(19) United States
(12) Patent Application Publication
(10) Pub. No.: US 2007/0190491 A1
(43) Pub. Date: Aug. 16, 2007

(54) Out-of-round implant and method of installing the same

(75) Inventor: Graham Blackbeard, Irene (ZA)

Correspondence Address: ROTHWELL, FIGG, ERNST & MANBECK, P.C., 1425 K STREET, N.W., SUITE 800, WASHINGTON, DC, 20005, US

(73) Assignee: Southern Implants (Pty) Ltd., Irene (ZA)

(21) Appl. No.: 11/700,252

(22) Filed: Jan. 31, 2007

Related U.S. Application Data
(60) Provisional application No. 60/763,910, filed on Feb. 1, 2006.

(51) Int. Cl. A61C 8/00

(52) U.S. Cl. 433/174

(57) ABSTRACT

A dental or other bone implant is provided that is adapted to provide substantial primary stability without hindering blood supply through the trabeculae of the bone, and therefore, allowing for rapid osseointegration and good secondary stability. The implant may include a head portion that may include an external or internal connector. The implant also includes a shank having threads. The threads and/or the shank have a varying radius to form a threaded shank that is out-of-round having a plurality of lobes.

### CROSS-REFERENCE TO RELATED APPLICATIONS

This application claims priority to U.S. Provisional Patent Application No. 60/763,910, filed on Feb. 1, 2006, the entire contents of which are incorporated herein by reference.

### BACKGROUND OF THE INVENTION

1. Field of the Invention

The present invention relates to implants and, in particular, to a dental or other bone implant screw having a thread that can either be a parallel or a tapered screw thread.

2. Description of the Related Art

When a dental implant is to be inserted into a human jaw, a site in bone to place a dental implant must first be prepared. The most common practical method for preparing the insertion site is to use a rotary cutting instrument (e.g., using a bur or drill bit). However, a rotary cutting instrument creates a hole that is circular in cross section. Typically, such a hole is either conical in shape, with tapered walls, or cylindrical in shape with parallel walls. It is common to prepare a site which has a combination—the hole can be cylindrical at the apex and conical lower down—that is closer to the form of a natural tooth root and has stress distribution advantages.

There are two requirements in terms of stability of a dental implant. Primary stability is that stability which is evident at time of screwing the implant into the bone. It can be increased by under-sizing the site (i.e., the hole in the bone). As a result, the external threads on the implant squeeze into the hole, compressing the bone and giving high primary stability. However, a problem occurs when the implant compresses the bone: the blood vessels collapse in the bone, and hence cut off or cut down on the ability of the bone to heal or repair itself.

Secondary stability is the better known concept of osseointegration, which is the regeneration of new bone in extremely close proximity to the implant surface. Osseointegration takes place more rapidly when there is good blood supply through the trabeculae of the bone.

Both high primary stability and rapid strong secondary ability are desirable. However, present methods of achieving high primary stability (e.g., under-sizing the size of the implant site (hole in bone)) compresses the trabeculae, hinders the blood supply and hence hinders secondary stability (hinders osseointegration).

Thus, there is a need for new and improved dental implants that provide primary stability without unduly hindering secondary stability.

### SUMMARY OF THE INVENTION

According to an embodiment of the present invention, a dental implant is provided that is adapted to provide substantial primary stability without hindering blood supply through the trabeculae of the bone, and therefore, allowing for rapid osseointegration and good secondary stability.

According to embodiments of the present invention, a dental implant is provided that may include a head portion that may include an external or internal connector. The implant also includes a shank having threads. The threads and/or the shank have a varying radius resulting in a threaded shank that is out-of-round, thereby forming a plurality of lobes.

According to another embodiment of the invention, the implant is generally conical in shape, tapering inward from the head to the distal end.

According to another embodiment of the invention, the implant is generally cylindrical in shape having generally parallel outer sides from the head to the distal end.

According to another embodiment of the invention, the implant has an upper portion that is generally cylindrical in shape and a lower portion that is tapered.

According to an embodiment of the present invention, the threads are helical threads. The threads may include two, three or four lobes.

According to another embodiment of the present invention, the shank my have a generally circular cross section while the threads have a generally triangular cross section.

According to another embodiment of the present invention, only a substantial portion of the implant is out-of-round.

According to another embodiment, both the shank and the threads are out-of-round.

According to another embodiment of the present invention, the threads are fluted.

Further applications and advantages of various embodiments of the present invention are discussed below with reference to the drawing figures.

### BRIEF DESCRIPTION OF THE DRAWINGS

FIG. 1 is a cross-sectional view of a conventional implant.

FIG. 2 is a cross-sectional of an implant of the present invention having a perimeter that is out-of-round.

FIG. 3 is a cross-sectional an implant inserted into compressed regions of the bone, which provides primary stability.

FIG. 4 illustrates a perspective view of an implant with four lobes (where one of the lobes is hidden from view) according to an embodiment of the present invention.

### DETAILED DESCRIPTION OF THE PREFERRED EMBODIMENTS

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

According to an embodiment of the present invention, a dental implant is adapted to provide substantial primary stability without hindering blood supply through the trabeculae of the bone, and therefore, allowing for rapid osseointegration and good secondary stability. The implant may have a head with a connector, as well as a shank having threads. The implant may be made “out-of round” in cross section. For purposes of explanation, the implant includes zones or “lobes” that are on a greater radius than other zones. Preferably, the implant shall include three lobes, but can include any other number.

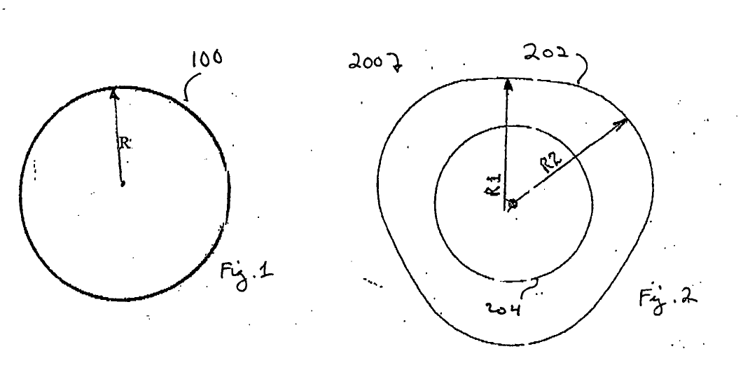

The cross section of a conventional implant is shown in FIG. 1. Implant 100 has a generally round cross section with a single radius R. However, most natural tooth roots, if cross sectioned, are not round but either tri-lobal or oval. Therefore, the round implant can give primary stability but will hinder blood flow and therefore, secondary stability of the implant.

FIG. 2 is a view of the cross section of an implant according to an embodiment of the present invention. As shown, implant 200 includes threads 202 forming an outer periphery of the implant having a shape that is out-of-round, i.e., the implant has a varying radius. Lobes are formed at the region of the implant where the radius of the threads R2 is greater than the radius R1 of other sections. In this embodiment, three lobes are formed where the diameter is R2 and three other sections have a diameter of R1. However, as already mentioned above, the present invention in not limited to the three-lobe configuration.

Although the radius of the shank 204 is shown as constant and therefore, the shank is not out-of-round as shown, the present invention is not intended to be limited to a round shank. Instead, both the threads and the shank may be out-of-round.

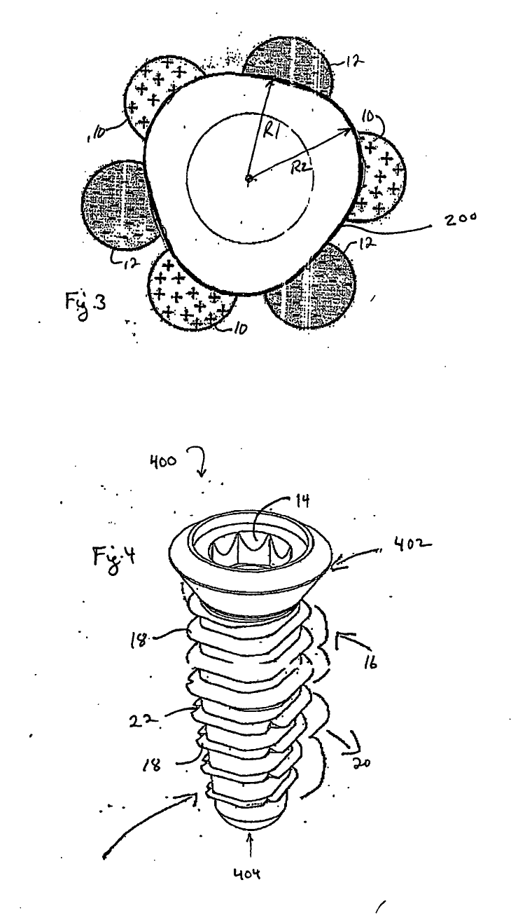

As shown in FIG. 3, the implant according to an embodiment of the present invention provides primary stability in the area where the lobes contact and compress the bone (zone 10). Moreover, the areas where the radius of the implant is smaller than that of the lobes provides low compression (zone 12) achieving a good blood supply to the region and hence, rapid osseointegration and development of secondary stability.

FIG. 4 is a perspective view of an implant according to an embodiment of the present invention. As shown, implant 400 has a head or apical end 402 with a connector 14, which may be an “internal” or “external” implant connection for connecting to an insertion tool (not shown) when surgically inserting the implant into the jaw bone, and for complemental receipt of an implant abutment element of a dental implant tooth structure (not shown). As shown, the shank 404 is threaded from the top of the implant to the bottom. The thread 18 may include fluted portions 22 cut into the threads 18 to facility cutting into the bone.

As described above, the implant may be conical or cylindrical. In this embodiment, a top portion 16 of the implant 400 has parallel sides to form a cylindrical section 16, while the remaining portion 20 of the implant 400 is tapered from the top to the distal end to form a conical section 20.

According to one embodiment, the externally threaded screw portion of the implant is conical along at least half the length thereof. In another embodiment, the externally threaded screw portion of the implant is conical along substantially the entire length, e.g., sections 16 and 20 of FIG. 4 may be conical.

One skilled in the art will understand that readily available fabricating machines and processes can be used to manufacture a screw thread to follow an out-of-round form, as described and shown herein.

While the invention is described above in terms of a dental implant, the implant of the present invention could also be used as a bone implant for arm or leg appendage bones (e.g., phalanges, femur, humerous), to enable fixation of an osseointegrated implant to, for example, a prosthetic finger, thumb, toe, leg or arm. These bones generally do not have as good a blood supply as do the jaws in which dental implants are placed. Therefore, the present invention can facilitate integration of such implants more rapidly. In such applications, the implants may be larger or smaller than dental implants and, because of the nature of the bones, can be cylindrical instead of conical.

Thus, a number of preferred embodiments have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention.

I claim:

1. A dental implant adapted to provide substantial primary stability without hindering blood supply through trabeculae of jaw bone, comprising:
an elongated shank having threads, said threads having a varying radius forming a plurality of lobes.

2. The dental implant as recited in claim 1, further comprising a head section having a connector.

3. The dental implant as recited in claim 1, wherein the implant is generally conical in shape, being tapered inward from a top end to a bottom end.

4. The dental implant as recited in claim 1, wherein the implant has generally parallel outer sides.

5. The dental implant as recited in claim 1, wherein the implant has an upper portion that is generally cylindrical in shape and a lower portion that is tapered.

6. The dental implant as recited in claim 1, wherein said threads are helical.

7. The dental implant as recited in claim 1, wherein said threads form at least two lobes.

8. The dental implant as recited in claim 1, where said threads form three lobes.

9. The dental implant as recited in claim 1, wherein a substantial portion of said threads are out of round.

10. The dental implant as recited in claim 1, wherein said shank has a generally circular cross section and said threads have a generally triangular cross section.

11. The dental implant as recited in claim 1, wherein a substantial portion of the implant is out-of-round.

12. The dental implant as recited in claim 1, wherein a substantial amount of said threads include fluted portions.

13. The dental implant as recited in claim 12, wherein said fluted portions are located on said lobes.

14. A method of installing an implant into bone tissue through an external surface of said bone tissue, said method comprising steps of:
preparing a bore in said bone tissue through the external surface of said bone tissue;
providing an implant adapted to provide substantial primary stability in said bore without hindering blood supply through the bone tissue, said implant comprising an elongated shank having threads, said threads having a varying radius forming a plurality of lobes;
screwing said implant into said bore.

15. The method as recited in claim 14, wherein said implant further comprises a head section having a connector.

16. The method as recited in claim 14, wherein the implant is generally conical in shape, being tapered inward from a top end to a bottom end.

17. The method as recited in claim 14, wherein the implant has generally parallel outer sides.

18. The method as recited in claim 14, wherein the implant has an upper portion that is generally cylindrical in shape and a lower portion that is tapered.

19. The method as recited in claim 14, wherein said threads are helical.

20. The method as recited in claim 14, wherein said threads form at least two lobes.

21. The method as recited in claim 14, where said threads form three lobes.

22. The method as recited in claim 14, wherein a substantial portion of said threads are out of round.

23. The method as recited in claim 14, wherein said shank has a generally circular cross section and said threads have a generally triangular cross section.

24. The method as recited in claim 14, wherein a substantial portion of the implant is out-of-round.

25. The method as recited in claim 14, wherein a substantial amount of said threads include fluted portions.

26. The method as recited in claim 25, wherein said fluted portions are located on said lobes.

27. The implant as recited in claim 1 having an externally threaded screw portion that is conical along at least half its length.

28. The implant of claim 27 wherein the externally threaded screw portion is conical along substantially its entire length.

29. The method as recited in claim 14, wherein said implant has an externally threaded screw portion that is conical along at least half its length.

30. The method as recited in claim 29 wherein the externally threaded screw portion is conical along substantially its entire length.

31. An implant for an arm or leg appendage bone adapted to provide substantial primary stability without hindering blood supply through arm or leg appendage bone, comprising:
an elongated shank having threads, said threads having a varying radius forming a plurality of lobes.

32. The implant as recited in claim 31, further comprising a head section having a connector for receiving a prosthetic.

33. The implant as recited in claim 31, wherein the implant is generally conical in shape, being tapered inward from a top end to a bottom end.

34. The implant as recited in claim 31, wherein the implant has generally parallel outer sides.

35. The implant as recited in claim 31, wherein the implant has an upper portion that is generally cylindrical in shape and a lower portion that is tapered.

36. The implant as recited in claim 31, wherein said threads are helical.

37. The implant as recited in claim 31, wherein said threads form at least two lobes.

38. The implant as recited in claim 31, where said threads form three lobes.

39. The implant as recited in claim 31, wherein a substantial portion of said threads are out of round.

40. The implant as recited in claim 31, wherein said shank has a generally circular cross section and said threads have a generally triangular cross section.

41. The implant as recited in claim 31, wherein a substantial portion of the implant is out-of-round.

42. The implant as recited in claim 31, wherein a substantial amount of said threads include fluted portions.

43. The implant as recited in claim 42, wherein said fluted portions are located on said lobes.
